(19) United States
(12) Patent Application Publication
(10) Pub. No.: US 2017/0098231 A1
(43) Pub. Date: Apr. 6, 2017

(54) SYSTEMS TO SUBSIDIZE VEHICLE-OWNERSHIP RIGHTS BASED ON SYSTEM-DRIVER INTERACTIONS

(71) Applicant: GM Global Technology Operations LLC, Detroit, MI (US)

(72) Inventor: Edgar J. Dietrich, Palo Alto, CA (US)

(21) Appl. No.: 15/232,328

(22) Filed: Aug. 9, 2016

Related U.S. Application Data
(60) Provisional application No. 62/235,867, filed on Oct. 1, 2015.

(51) Int. Cl. G06Q 30/02; G07C 5/02; G06N 5/04; H04L 29/08; G05B 15/02

(52) U.S. Cl. CPC G06Q 30/0212; H04L 67/12; G06Q 30/0239; G05B 15/02; G06N 5/04; G07C 5/02

(57) ABSTRACT

A system, for providing subsidized vehicle-ownership rights based on driver participation in a driver-participation incentive program. The system includes a processing hardware unit, or processor, and a system-driver agreement module configured to, via the processor, establish an agreement by which the driver participant agrees to perform a vehicle-driving-related task in exchange for a subsidy toward obtaining the vehicle-ownership rights. The system also includes an account-maintenance module establishing a driver-participation account in connection with the driver participant. The system also includes a system-driver interface module resenting, by way of a tangible vehicle interface, a task for the driver to perform, and determining that the driver participant performed the task. The system further includes a driver-incentives module that, via the processor: adds program points to the driver-participant account if the driver performed the task; and applies the program points to the subsidy toward obtaining the vehicle-ownership rights.

### TECHNICAL FIELD

The present disclosure relates generally to a system to subsidize vehicle-ownership rights for a driver participant and, more particularly, to subsidize vehicle ownership based on interactions between the driver participant and the system.

### BACKGROUND

Automobiles play an important role in modern life. Many people have trouble obtaining automobile-ownership rights, though. They may lack funds to purchase or lease, for instance, or have insufficient credit to qualify for attractive financing.

### SUMMARY

There is a need for systems configured to manage a program for subsidizing vehicle-ownership rights based on system-driver interactions. Vehicle-driver-participant activities in various embodiments include interacting with the system and performing one or more related tasks.

For implementations in which the system includes or is part of the vehicle, such as an automobile, ownership rights in the automobile are granted based on inter-activities that the driver participant has agreed to have with the system, such as by watching a pre-selected video, presented by a program partner, and completing a poll by way of a human-machine interface (HMI) of the vehicle.

Other aspects of the present technology will be in part apparent and in part pointed out hereinafter.

### DESCRIPTION OF THE DRAWINGS

FIG. 1 illustrates schematically an automobile comprising an interface system according to embodiments of the present disclosure.

FIG. 2 illustrates a first example system-user interface device.

FIG. 3 illustrates a second example system-user interface device.

FIG. 4 illustrates schematically an arrangement of interacting components according to embodiments of the present disclosure.

FIG. 5 illustrates a method of using the vehicle and system of FIG. 1 according to embodiments of the present disclosure.

The figures are not necessarily to scale and some features may be exaggerated or minimized, such as to show details of particular components. In some instances, well-known components, systems, materials or methods have not been described in detail in order to avoid obscuring the present disclosure. Specific structural and functional details disclosed herein are not to be interpreted as limiting, but merely as a basis for the claims and as a representative basis for teaching one skilled in the art to variously employ the present disclosure.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model, or pattern.

Specific structural and functional details disclosed herein are not to be interpreted as limiting, but merely as a basis for the claims and as a representative basis for teaching one skilled in the art to employ the present disclosure.

### I. OVERVIEW OF THE TECHNOLOGY

Systems of the present disclosure are configured to subsidize vehicle-ownership rights for a driver participant based on system-driver interactions.

The target user audience for the technology includes people who could use or would like to subsidize the cost of vehicle ownership in exchange for their time and activity including interacting with the system.

The system in various implementations includes or is part of an automobile. In these cases, ownership rights in the automobile are granted based on an agreement between the driver participant and system relating to interactions that the driver participant will make at least in part with the automobile.

The target user audience for the technology includes people who could use or would like to subsidize the cost of vehicle ownership in exchange for their time and activity including interacting with the system.

The systems and methods of the present technology in some embodiments can be used to subsidize ancillary services related to vehicle ownership or operations, for instance, such as services providing any of subscription-based communications, or communications connectivity, licenses, subscriptions, or other rights to digital content or services, in-vehicle security, hands-free calling, turn-by-turn navigation, and remote diagnostics.

While the present technology is described primarily in connection with automobiles, the technology is not limited to automobiles. The concepts can be used in a wide variety of applications, such as in connection with aircraft and marine craft.

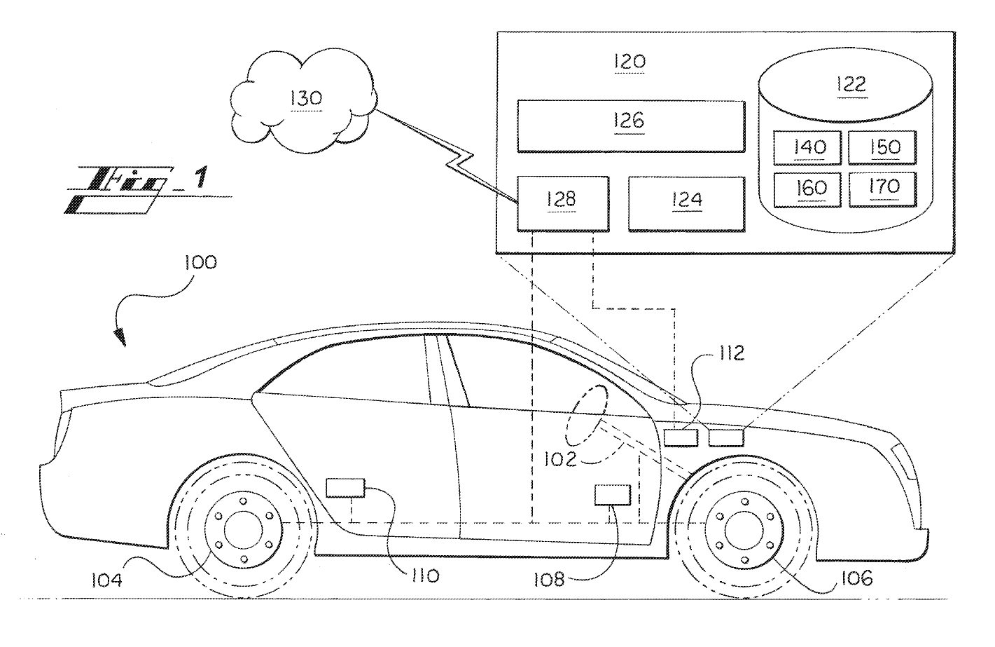

### II. SYSTEM COMPONENTS—FIGS. 1-4

Now turning to the figures, and more particularly to the first figure, FIG. 1 illustrates a schematic diagram of a vehicle 100 configured according to the present technology. The vehicle 100 is, in various embodiments, an automobile, such as an autonomous-driving-capable automobile.

### II.A. Primary Exemplary System Components—FIG. 1

Vehicle components include a steering assembly 102, one or more braking assemblies 104, 106, and an acceleration assembly 108. Other vehicle-control components that can be used with the present technology are indicated generically at reference numeral 110. In various embodiments, the vehicle-control components are computer controllable to affect driving of the vehicle.

The vehicle 100 also includes one or more vehicle-driver interfaces 112. The vehicle-driver interface(s) 112 include hardware by which a driver participant can provide input to and/or receive output from a computerized controller of the vehicle. The driver participant can be referred to as an owner-driver participant, as they are working toward ownership rights in the vehicle 100.

The interface(s) 112, like all components described herein, can be referred to by a variety of terms. The interface(s) 112 can be referred to, for instance, as a vehicle-driver interface (VDI), a human-machine interface (HMI), a vehicle input, a vehicle I/O, or the like.

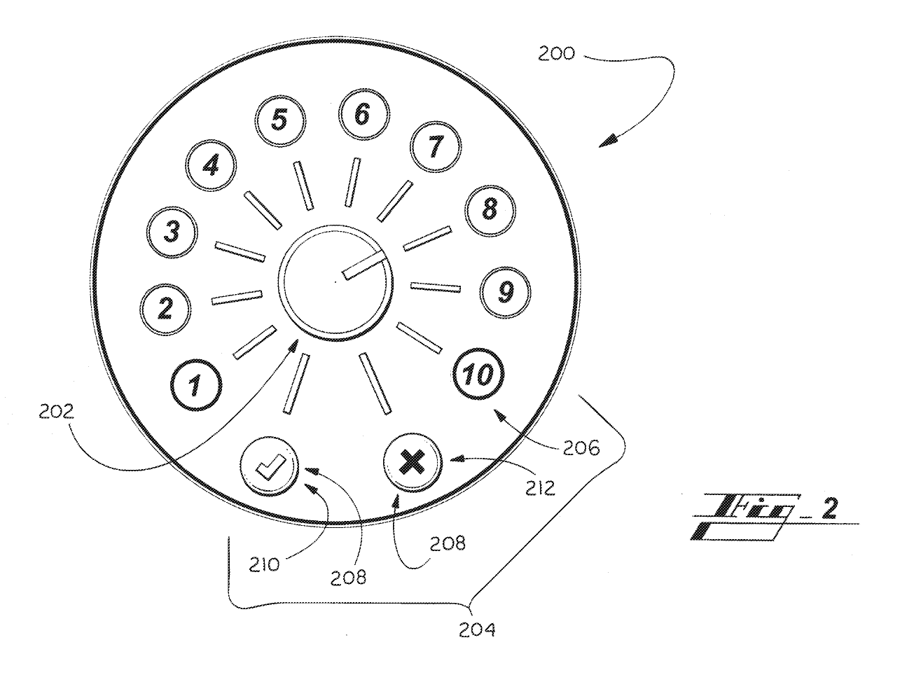

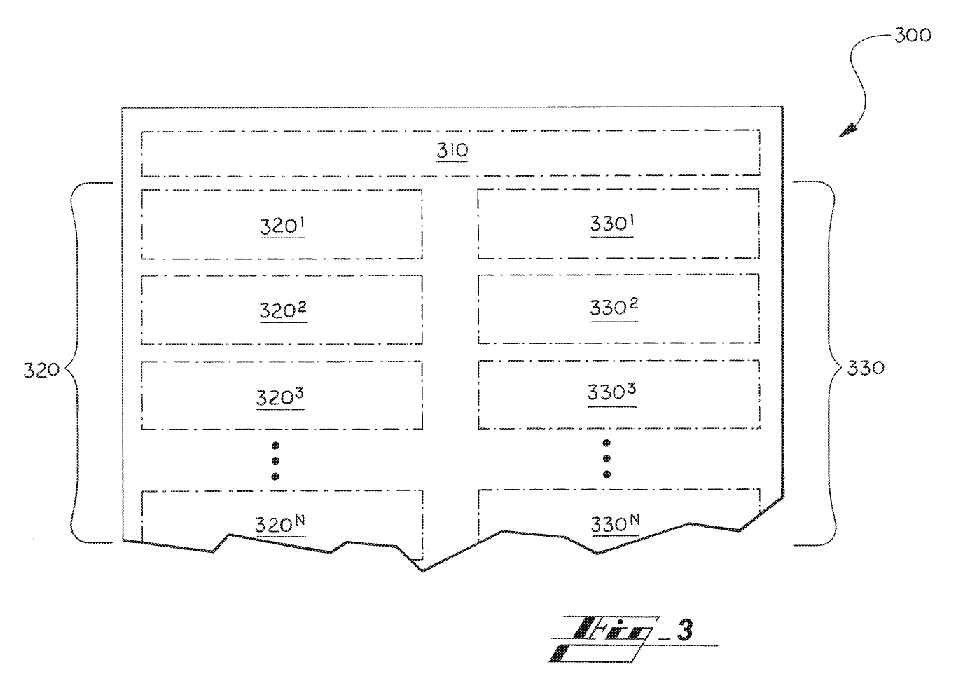

The input devices 112 can include in-vehicle knobs or dials (see FIG. 2, for instance), touch-sensitive screens (FIG. 3 for instance), microphones, cameras, laser-based sensors, other sensors, or any device suitable for monitoring or receiving communication from the owner-driver participant. Driver communications can include, for instance, button pushes, on-screen presses or swipes, or other gestures. Driver-participant communications can also include audible sounds such as voice communications, utterances, or sighs from the owner-driver participant.

Although the system is described herein primarily in connection with system-driver interactions, the system and/or vehicle 100 are in various embodiments configured also to facilitate relevant interactions between the system and another user, such as a front- or rear-seat passenger of the vehicle 100. Descriptions of functions provided herein with respect to an owner-driver participant, or user, can be equally applied together with, or separate from, implementation of the functions in connection with the owner-driver participant.

### II.B. First Example HMI—FIG. 2

FIG. 2 shows schematically an example HMI 112 in the form of a dial arrangement 200. The dial arrangement 200 in one embodiment includes a knob 202 or other component configured to allow the owner-driver participant or other user (e.g., passenger) to make selections.

In a contemplated embodiment, the vehicle 100 includes one or more dial arrangements 200, such as one in a fore compartment for the driver and front-seat passenger, and one or more in the aft compartment for back-seat passengers.

In the illustrated example, selection options 204 include selection numerals, letters, or other symbols 206, and a binary selector 208. The binary selector 208 can represent, depending on the issue or questions being presented to the owner-driver participant, a positive option 210 and a negative option 212, such as yes/no, like/dislike, approve/disapprove, and agree/disagree.

As one exemplary application, an owner-driver participant may be asked, as part of vehicle-driver interaction supporting the vehicle-ownership subsidy, to drive, at a convenient near-term time for the owner-driver participant, to a new local storefront and rate curb appeal of the property. The task can be presented to the owner-driver participant in a variety of ways, such as audibly by speaker and/or by a display screen. The owner-driver participant can be asked to rate the curb appeal by selecting, via the dial 202, a number between 1 being the lowest rating and 10 being the highest.

As another exemplary application, a user may be asked, as part of vehicle-user interaction supporting the vehicle-ownership subsidy, to, before moving the vehicle from park, view a short video advertisement via a vehicle display and indicate by the binary option 208 whether they found the product or service advertised appealing (210) or not (212).

The system and dial apparatus 200 can be configured to allow the owner-driver participant to register their selection in a variety of ways, such as by depressing the knob 202.

The structure for the dial arrangement 200, including the options shown, are merely examples. A designer of the system has great latitude to design the arrangement in many other ways depending on the expected uses and user-vehicle interactions contemplated.

### II.C. Second Example HMI—FIG. 3

FIG. 3 shows schematically an example HMI 112 in the form of a display device 300. The display device 300 includes a screen that is in some embodiments touch-sensitive to allow receipt of driver-participant input.

Although the display device 300 is described primarily in the context of a touch-sensitive screen, the device 300 can take other forms, such as a head-up display apparatus, or a holographic-display apparatus. The device 300 in any of these cases can be configured and arranged with other components of the vehicle 100 to (i) allow display of information—including text and/or graphics, for instance, in various embodiments—to the owner-driver participant or (ii) allow display of such information and receipt of drive input.

In various embodiments, the system is configured to display any of a wide variety of information by way of the screen 300. In a contemplated embodiment, the screen device 300 displays options like those in FIG. 2. (Contemplated embodiment not shown expressly in FIG. 3). The system in various embodiments arranges the information in a heading or subject section 310, a task or item section 320, and a details section 330.

The subject section 310 can be used to display categorizing-type information, such as a name associated with a driver-participant or a reference to a user account or profile. In various implementations, the section 310 indicates a group or theme associated with the items 320 and details 330 being presented—for example, sports-related media or women's interests.

The item section 320 can include any number (N) of items 320¹, 320², 320³ . . . 320^{N}. The details section 330 can likewise include a corresponding number (N) of details 330¹, 330², 330³ . . . 330^{N}. In one embodiment the system can, by way of the display apparatus 300, and particularly the item section 320, present various tasks 320¹, 320², 320³ . . . 320^{N} from which the owner-driver participant can select a task that the owner-driver participant would be interested in performing as part of their participation in the vehicle-ownership subsidy program. The system can also, then, present, by way of the display apparatus 300, various details 330¹, 330², 330³ . . . 330^{N} details about the tasks, such as a number of program credits or points that the owner-driver participant can earn for performing the task, and/or a time period by which the task would need to be completed.

As a particular example, the system can be configured to display a first task option (320¹) that would involve the owner-driver participant using a coupon code for a free product at a local location of a national drug store chain who is a program partner, and rating the packaging or utility of the product. Program partners can be referred to by other terms such as program sponsors, program advertisers, partner participants, the like, or other.

A second task option (320²) can involve the owner-driver participant viewing two short (e.g., thirty-second) advertisements for a product or service and being asked to select which advertisement was most appealing. A third task option (320³) could involve the driver scanning quick-response (QR) codes of packaging for products provided by a particular consumer-goods company and posting a photo of a favorite one of them to a social media page of the owner-driver participant, and so on (320^{N}).

Other example optional or required tasks for system-driver interactions using the contemplated display screen apparatus 300 of FIG. 3 are provided below.

### II.D. Hardware-Based Controller—FIG. 1, Cont.

The systems described herein are implemented by hardware including that of one or more computerized controllers. With continued reference to the first figure, FIG. 1 shows schematically such a computerized controller, or control system, at numeral 120. It is contemplated that the control system 120 can be implemented in one or more of a variety of forms, such as an onboard computer, a server, and/or a mobile-communication device, for example.

Although connections are not shown between all of the components illustrated in FIG. 1, the components can interact with each other to carry out system functions.

As shown, the control system 120 includes a memory, or computer-readable storage device 122, such as volatile medium, non-volatile medium, removable medium, and non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The control system 120 also includes a processing hardware unit 124 connected or connectable to the computer-readable storage device 122 by way of a communication link 126, such as a computer bus.

The processing hardware unit 124 can include or be multiple processors, which could include distributed processors or parallel processors in a single machine or multiple machines. The processing hardware unit can be used in supporting a virtual processing environment. The processing hardware unit could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

The computer-readable storage device 122 includes computer-executable instructions, or code. The computer-executable instructions are executable by the processing hardware unit 124 to cause the processing hardware unit, and thus the control system 120, to perform any combination of the functions described in the present disclosure.

The storage device 122 is in various embodiments divided into multiple modules 140, 150, 160, 170, each comprising or being associated with code causing the processing hardware unit 124 to perform functions described herein.

The control-system modules 140, 150, 160, 170 in various embodiments include a system-driver agreement module 140, a system-driver interaction module 150, an incentives-and-monitoring module 160, and one or more other modules 170.

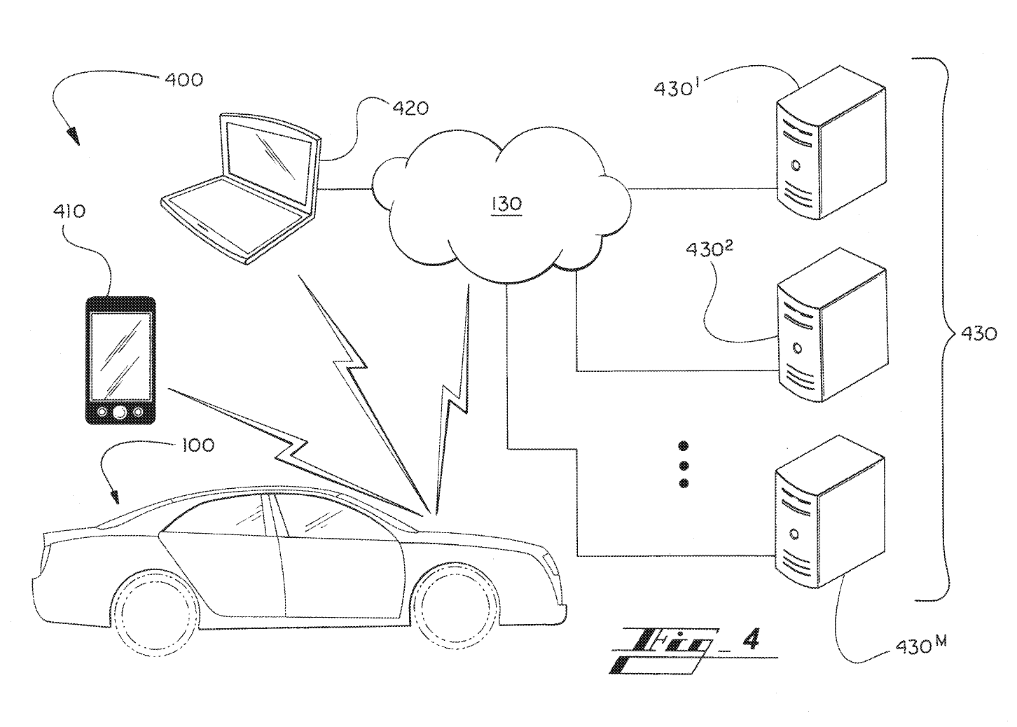

In various embodiments, any one or more of the modules 140, 150, 160, 170 is in part or fully a component of a computer system remote to the vehicle 100. For example, the system-driver agreement (SDA) module 140 is in various embodiments a part of a primary vehicle-ownership-subsidy server 430¹, described more below in connection with FIG. 4.

As another example, the system-driver-interaction (SDI) module 150 in various embodiments comprises at least one first, driver-vicinity, component stored and operated at the vehicle 100 or mobile-communication device 410 (FIG. 4), for instance, and a second, remote, component, configured to interact with the first component in performing operations of the present technology. In one embodiment, the remote component generates optional or required tasks, or otherwise obtain them (e.g., from a secondary server 430² . . . 430^{M} (FIG. 4)) and passes the information to the local component for presentation and corresponding implementation through interaction with the owner-driver participant.

### II.E. System-Driver Agreement Module—FIG. 1, Cont.

With continued reference to FIG. 1, the system-driver agreement (SDA) module 140 is configured with computer-executable code designed to cause the processing hardware unit 124 to perform functions related to generating a system-driver agreement. In some embodiments, the functions include presenting the agreement for review by the owner-driver participant. In some embodiments, the functions include receiving vehicle-driver-participant agreement to the SDA.

Functions of the SDA module 140 can also include establishing and maintaining a driver-participant account or profile. The account can include information such as terms of the agreement, driver-participant performance under the agreement, driver-participant points, dollar values, or other incentives earned by the owner-driver participant in connection with the program.

The system-driver agreement can include, for instance, an agreement that the user makes for obtaining a subsidy toward vehicle-ownership rights. The agreement indicates the scope of the subsidy and related user tasks that the owner-driver participant will provide in return.

In a contemplated embodiment, the agreement requires that the owner-driver participant perform one or more basic functions as part of driver-participant obligations to earn the vehicle-ownership subsidy. The system 120 may be configured to require, for instance, that the owner-driver participant view a short video when the participant first engages the vehicle ignition each day, while the vehicle is still parked. Interactions are, in various implementations, facilitated while the user is driving in a non-obtrusive manner, such as a gentle voice chiming in with a recommendation, or a request for permission to share a recommendation or advertisement in exchange for points or other incentive for the driver related in connection with the program.

Other example tasks include those which ask the owner-driver participant to (i) view a short video advertisement via a vehicle display, and indicate by the binary options 208 (FIG. 2) whether they find the product or service appealing (option 210) or not (option 212), (ii) use a coupon code for a free product at a local drug store, and rating the packaging or utility of the product, (iii) view two brief advertisements for a product or service and select which advertisement was most appealing, and (iv) scan QR images of a plurality of packages for products provided by a particular consumer-goods company, and posting a photo of a favorite one of them to a social media page of the owner-driver participant.

In one embodiment, the owner-driver participant interacts with the system by way of a mobile device, such as a tablet, smartphone, smartwatch, smart glasses, or the like, connected via wifi or bluetooth to the system, such as an in-vehicle component and/or remote components. The arrangement can be configured so that any function described herein in connection with the vehicle—such as vehicle display of task options for the owner-driver participant, or vehicle receipt of owner-driver participant input indicating selection of a task, feedback for a task, or settings or preferences—can be performed via the mobile device, and vice versa.

In one embodiment, driver-participant performance includes displaying an advertising element on an exterior surface of the vehicle for being viewed by others. In one embodiment, driver-participant performance includes displaying the advertising element on an interior surface of the vehicle for being viewed by others. such as on a part of a front or rear of a car seat of the vehicle. The advertising element can include, for instance, decals, paint jobs, signage (e.g., roof signage), or the like, of logos or other branding for a company or product. In various embodiments, the advertising element is attached in a non-obstructive manner to an exterior surface of the vehicle (e.g., doors, hood, roof, etc.), or attached to a seat headrest.

Cost may be saved in vehicle production by use of vehicle covering, such as decals or paint jobs. A vehicle manufacture who also administrators the program of the present technology can save money in vehicle manufacturing by obviating some painting, enabling painting in a less-expensive manner, or using less-costly metal finishes for surfaces to be covered by decals of a program partner.

For embodiments in which program partners and/or potential program partners compete to sponsor program engagements of the present technology, the competition could spur development of attractive and engaging physical vehicle modifications, which get the advertiser's message across and are desirable alternatives for drivers to vehicles with no modifications.

Other types of driver-participant performances, and other user performances—e.g., passenger performances, are described below.

The subsidy in various embodiments includes a one-time or multiple-time discount to the cost of vehicle ownership. The discount in one implementation includes a percentage or a dollar-value discount off of monthly payments on new-vehicle purchase financing, monthly payments on a vehicle-lease program, or of monthly payments on a vehicle-share program. The latter type of program, vehicle-share program, can be referred to by other names, such as car sharing.

The present technology can incorporate any of a wide variety of vehicle-share programs. These programs can also be referred to as vehicle pool programs or systems. A vehicle-share program can involve multiple participants purchasing a shared vehicle-ownership right in one or more subject vehicles, for instance. Each owner has rights to use the one or more subject vehicles according to a pre-arranged schedule. The arrangement specifies when owners can use the shared vehicle(s). The arrangement may specify, for instance, that the owners can sign up for time slots online for using the vehicle.

Or the arrangement can specific pre-arranged time slots that each owner can use the vehicle(s). As an example, a participant may be part of a program whereby the participant can use a sedan between 5:00 a.m. and 3:00 p.m. on weekdays and a small sports-utility vehicle (SUV) between Saturday at 4:00 p.m. and Sunday at 1:00 p.m. Others in the same program have other rights, such as another having the right to use the sedan between 4:00 p.m. and midnight on weekdays and the SUV between Sunday at 3:00 p.m. and midnight.

While the present systems and methods are described herein primarily in connection with subsidizing vehicle ownership based on system-driver interactions, the technology is not limited to this implementation and can be applied in other contexts.

The systems and methods can be used to subsidize ancillary services related to vehicle ownership or operations, for instance, such as services providing any of subscription-based communications, or communications connectivity, licenses, subscriptions, or other rights to digital content or services, in-vehicle security, hands-free calling, turn-by-turn navigation, and remote diagnostics. An example service that can be subsidized is the OnStar® system, which provides each of these services. (ONSTAR is a registered trademark of the OnStar Corporation, a subsidiary of the General Motors Company)

### II.F. System-Driver-Interaction Module—FIG. 1, Cont.

With continued reference to FIG. 1, the system-driver-interaction (SDI) module 150 is configured with computer-executable code designed to cause the processing hardware unit 124 to perform functions related to interacting with the owner-driver participant in support of the subsidy. The interactions can be summarized in the system-driver agreement.

The functions can include, for instance, generating or otherwise obtaining action items 320 and corresponding details 330, as mentioned in connection with FIG. 3. The items and details can be obtained from one or more remote servers described further below, for instance.

Additionally, SDI-module functions can include presenting action items 320 and details 330, and performing follow-on functions such as confirming driver-participant performance.

In some embodiments, the SDI module 150 is configured to perform follow-on functions such as confirming that the driver-participant completed performance of a task. Confirming driver-participant performance can include, for instance, receiving a response provided by the owner-driver participant by way of the interface 112, such as a rating of a product or store.

The driver-participant performance can include the owner-driver participant posting a message or image to a social media account associated with the owner-driver participant. Confirming that task is completed can include interacting with remote computer systems. The interactions can be made by way of application program interfaces (APIs) of the remote systems. As an example, if a task involves the driver-participant uploading a photo of a product to a social-media site, the system can confirm that the upload was made. The confirmation can be performed in a variety of ways, such as by the user sending a screen shot of their social-media page updated as such. In another contemplated embodiment, the system or the program partner participant is subscribed to the social media page so that the system or a system of the program partner participant can receive a message indicating, or otherwise discern, that the social-media page has been updated as requested by the task. In another embodiment, even without subscription the system or program partner participant system receive a message, such as an email confirming that the social-media page has been updated according to the task.

### II.G. Incentives-and-Monitoring Module—FIG. 1, Cont.

With continued reference to FIG. 1, the incentives-monitoring (IM) module 160 is configured with computer-executable code designed to cause the processing hardware unit 124 to perform functions related to monitoring and ensuring that the owner-driver participant perform a required level of system-driver interactions to earn the subsidy, in accord with the driver-participant agreement.

The IM module 160 can be configured to, along with or instead of the system-driver-agreement (SDA) module 140, establish the driver-participant account and/or perform maintenance functions for the driver-participant account. The maintenance functions include, for example, recording extents to which the owner-driver participant is performing, according to the corresponding driver-participant agreement, and associated driver-participant points, dollar values, or other incentives earned.

### II.H. Other System Modules—FIG. 1, Cont.

The fourth illustrated module 170 of FIG. 1 represents one or more additional modules. Example functions that code of the additional module(s) 170 can cause the processing hardware unit 124 to perform include (i) interfacing with application program interfaces (APIs) of third-party vendor applications or servers to perform functions described herein, (ii) providing driver-participant status reports of performance, (iii) providing driver-participant reminders of tasks to be performed, (iv) tracking or monitoring system-driver interactions, (v) generating recommendations, such as a recommendation that the system provide only or mostly sports-related tasks to the owner-driver participant based on results of system-driver interaction tracking, (vi) advertising the arrangement provided by the present technology, and/or (vii) others.

### II.I. Modules Summary—FIG. 1, Cont.

Modules 140, 150, 160, 170 can be referred to by a wide variety of terms including by functions they are configured to perform. According to the fifth (v) example of the preceding paragraph, for instance, the module 170 can be referred to as a driver-recommendation (DR) module, a recommendation module, or the like.

Any functions described herein in connection with separate modules can in another embodiment be performed by the processing hardware unit 124 executing code arranged in a single module. And any functions described herein in connection with a single module can be performed instead by the processing hardware unit 124 executing code of more than one module.

### II.J. Other Control System Components and Functions

The control system 120 further comprises an input/output (I/O) device 128, such as a wireless transceiver and/or a wired communication port. The device 128 can include or be a part of a tangible communication device. The processing hardware unit 124 sends and receives information by way of the I/O device 128, and executing the instructions, including those of the mentioned modules 140, 150, 160, 170. The information can be transmitted in the form of messages or packetized data, to and from one or more vehicle components, including the vehicle control components 102, 104, 106, 108, 110 mentioned.

In some implementations, the I/O device 128 and processing hardware unit 124 are configured such that the processing hardware unit 124, executing the instructions, sends and receives information to and from one or more networks 130 for communication with remote systems. Example networks 130 are the Internet, local-area networks, and other computing networks, and corresponding network-access devices such as cellular towers, satellites, and road-side short- or medium-range beacons facilitating vehicle-to-infrastructure (V2I) communications.

### III. NETWORKS AND REMOTE DEVICES—FIG. 4

The referenced networks 130 (FIG. 1) include or are connected to multiple remote devices or systems, such as servers or mobile-communication devices, in various embodiments.

FIG. 4 shows an arrangement 400 including various interacting components. Devices at or remote to the vehicle 100 can include a driver-participant mobile-communications device (MCD) 410, such as a smartphone or tablet, a driver-participant computer 420, such as a laptop or personal computer, and one or more servers 430.

Any of the computer devices described herein, such as those 410, 420, 430 mentioned in the preceding paragraph, can include computing components having hardware like that described for the hardware-based computing system 120 of FIG. 1. Each can include its own tangible computer-readable storage device comprising instructions that when executed by a processing hardware unit perform various functions of the present technology.

The MCD 410 can connect to the vehicle 100 via one of the networks 130, or directly by way of a short-range communication protocol such as Bluetooth.

One of the servers 430¹ can be in communication with another of the servers 430². Any number (M) of servers can be connected, such as by way of the network(s) 130.

A first server 430¹ is in one embodiment a server of an administrator of the vehicle-ownership subsidy program of the present technology. One or more of the other servers 430² . . . 430^{M} can be associated with one or more entities participating in one way or another with the vehicle-ownership subsidy program. One of the servers 430² . . . 430^{M} can be associated with a program partner/advertiser participating in the program, and interact with the intermediate or primary server 430¹ to perform functions related to system-driver interactions. The system-driver interactions can include any of the examples mentioned herein, such as the owner-driver participant receiving an optional or required task.

An example entity operating one of the additional servers 430² . . . 430^{M} includes a service or product provider. The additional servers 430² . . . 430^{M} can provide tasks and associated details to the intermediate or primary server 430¹, such as by way of the network 130.

The additional servers 430² . . . 430^{M} also in embodiments provide information supporting generation and monitoring of driver-participant performance vis-à-vis requirements of the system-driver agreement. The information can be provided to the system-driver agreement (SDA) module 140 described above, for instance, whether the SDA module 140 is a part of the vehicle 100 and/or the primary server 430¹.

The primary server 430¹ receives and processes information received, such as information regarding tasks and details, and processes the information for presentation to the owner-driver participant. The primary server passes on the information processed by way of the network 130 and a device, such those 410, 420, 100 shown in FIG. 4.

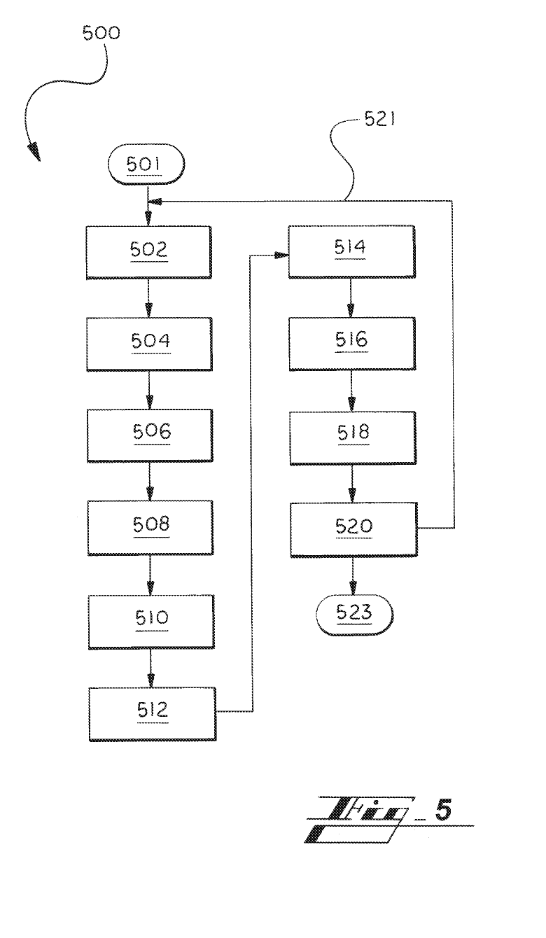

### IV. ALGORITHMS AND METHODS OF OPERATION—FIG. 5

FIG. 5 shows an algorithm by which the present technology is implemented, outlined by flow chart as a method 500, for subsidizing vehicle ownership based on interactions between the owner-driver participant and the system according to embodiments of the present disclosure.

It should be understood that operations of the method 500 are not necessarily presented in any particular order and that performance of some or all the operations in an alternative order is possible and is contemplated. The operations have been presented in the demonstrated order for ease of description and illustration.

Operations can be added, omitted and/or performed simultaneously without departing from the scope of the appended claims. It should also be understood that the illustrated method 500 can be ended at any time. In certain embodiments, some or all operations of this process, and/or substantially equivalent operations are performed by at least one processing hardware unit 124 executing computer-readable instructions stored or included on a computer readable medium, such as the memory 122.

The method 500 begins 501 and flow proceeds to block 502, whereat the processing hardware unit generates or otherwise obtains a driver-specific subsidized-vehicle-ownership account. The processing hardware unit (computer processor) can perform these functions using the system-driver agreement (SDA) module 140, or one of the other modules 170, described above, for example. Generating the account can include populating the account with driver participant demographic information received from the driver participant, such as age, residence, etc., for instance,

At block 504, the processing hardware unit generates or otherwise obtains a system-driver subsidized-vehicle-ownership (SDSVO) agreement. The processing hardware unit can perform these functions using the system-driver agreement (SDA) module 140, for example. The SDSVO agreement can be presented to the owner-driver participant by the system in any of a variety of ways, such as via a vehicle HMI, printed form, a driver-participant mobile-communication, or a driver-participant home computer or laptop.

Functions of block 504 can also include receiving an owner-driver participant communication approving the SDSVO agreement. An approval communication can be received at the system in any of a variety of ways, such as via the vehicle HMI, a signed printed form, or a driver mobile-communications device, for instance.

In one embodiment, the agreement between the owner-driver participant and the system indicates performances that the owner-driver participant will need to make including interacting with the automobile. In a contemplated embodiment, the agreement requires that the owner-driver participant perform one or more basic functions as part of driver-participant obligations to earn the vehicle-ownership subsidy.

The SDSVO agreement may require, for instance, that the owner-driver participant view a short video when the participant first engages a subject vehicle ignition each day while the vehicle is still parked. As another example, the system 120 may be configured to require by the SDSVO agreement that the owner-driver participant maintain for display on their vehicle a pre-determined advertisement, such as a decal advertising a product or service of an entity participating in the program of the present technology. As another example, the system 120 may be configured to require by the SDSVO agreement that the owner-driver participant perform a certain amount or number of tasks within a set period of time. The SDSVO agreement may require, for instance, that the owner-driver participant perform one task per day for a duration of the SDSVO agreement.

Other potential embodiments include:
A. presenting the owner-driver participant with a task and receiving a coupon—the coupon can in some implementations be a reward or part of a reward for performing the task, and in some implementations redeeming the coupon could be a part of completing the task.
B. presenting the owner-driver participant with a task involving listening to a prescribed audio stream;
C. presenting the owner-driver participant with a task involving purchasing a certain amount of product(s) and/or service(s) from a retailer associated with the program;
D. presenting the owner-driver participant with messages or information associated with a recent vehicle sensor output—for instance, a discount tire store participating program partner could sponsor an engagement in which the partner's advertisement or discount is presented in connection with a diagnostics report from the vehicle for the driver that a tire is underinflated. (E.g., “We'll fill the tire for free and check each of your tires at any of our convenience locations”);
E. presenting the owner-driver participant with a task involving driving within a certain parameter, e.g., range of parameters—such as safe-speed driving, efficient driving (low acceleration levels, etc.)—and providing rewards for the same, such as insurance discounts from an insurance-company program partner; and
F. presenting the owner-driver participant with an incentive to be earned by the user owner-driver participant opting voluntarily into an anonymized data collection program.

At block 506, the processing hardware unit adjusts the driver-participant account to establish or activate a system-driver relationship in the account based on the owner-driver participant approving the SDSVO agreement. The processing hardware unit can perform these functions using the system-driver agreement (SDA) module 140 described above, for example.

In various embodiments, the functions of block 506 include, in connection with account activation, providing the owner-driver participant with access to the subject vehicle(s), such as by providing a code for accessing car keys to the subject vehicle(s) or for accessing the vehicle(s). Establishing ownership can include operations involved with transferring title, such as sending a certificate or other confirmation of ownership to the owner-driver participant.

At block 508, the processing hardware unit generators or otherwise obtains information related to one or more driver-participant tasks. The functions of block 508 can be performed by the system-driver interaction (SDI) module 150, for example, or another module 170 such as a task-obtaining module.

Obtaining the tasks can include the system connecting to a computing system—e.g., server—of a third party, such as a program participant/advertiser. The server can be contacted by way of an application-program interface (API), for instance. Program participants can include companies who have agreed to participate in the vehicle-ownership subsidy program described herein. Program participants can provide various contributions, such as funding, sample product offerings, proceed or profit splitting with a program administrator, or other, in exchange for receiving advertising or promotion regarding their product or service.

The information can include an identification of the tasks and supporting details, as described above in connection with the exemplary HMI screen 300 of FIG. 3. Some tasks can be required by the SDSVO agreement and some can be options from which the driver must choose.

Example task/detail combinations include:

| Task/Engagement | Detail |
|---|---|
| Try a new personal grooming product and post a photo of | 10 |
| the product to your social media site | points |
| Sample a new energy drink with at least one friend and | 15 |
| post a selfie of the group drinking it to your social media | points |
| site | |
| Watch three commercials, and answer questions about | 5 |
| them, by way of the vehicle HMI | points |
| Complete a three-part “social quest” - an urban | 30 |
| scavenger hunt coordinated over the internet and | points |
| sponsored by a new detective movie from XYZ motion | |
| picture studios. | |
| Listen to ten hours of ad-supported audio streaming | 15 |
| | points |
| Participate in a promotion and enlist a friend or be | 10 |
| enlisted by an existing promotion participant (e.g., be a | points |
| “Support Partner” for a family member in Buick's “Active | |
| Run” promotion and take 10,000 steps a day, to be | |
| measured by your fitness-tracking device) | |
| Snap quick-response (QR) codes on five different | 5 |
| products of a particular consumer brand of a program | points & |
| partner, and answer short questions about the products | free trial |
| during a trip to particular) drug store. | product |
| | from the |
| | brand |
| Service the vehicle at an approved center at | 30 |
| recommended intervals | points |
| Drive ten miles out of usual work-home commute to visit | 10 |
| a newly opening restaurant, and check in there on one of | points |
| a few select social media sites | |
| Fill up twice at a particular gas station, a program | 10 |
| partner. Users could be incented to visit multiple times by | points + |
| offering extra “Loyalty” points. | extra |
| | credit in |
| | partner- |
| | managed |
| | loyalty |
| | account |
| | for driver |
| Watch an average of two pre-ignition (before driving car) | 30 |
| videos per day in a month relating to target likes and | points |
| interests of the driver | |
| Enlist two friends to complete “info-quests” sponsored by | 40 |
| a consumer-packaged-goods company while on a road | Points |
| trip. The act would for them be a form “virtual gas money” | |
| contributed to the driver, who receives the corresponding | |
| program points. | |
| Maintain safe speeds (e.g., safe average speed; Funding | 20 |
| for the corresponding points provided by a related | points |
| program partner - e.g., insurance company) | |
| Keep tires inflated to the proper pressure (Funding for | 25 |
| the corresponding points provided by a related program | points |
| partner - e.g., tire company or insurance company) | |
| Opt into an anonymized data-logging program, which can | 15 |
| be provided as part of aggregated feedback to retailers | points |
| (e.g., program-partner retailers) on shopping patterns. | |
| Visit any specified program-partner establishment and | 50 |
| spend a target amount - e.g., $150 per month | points |
| Have a wrap on the exterior and interior dash surfaces of | 50 |
| a vehicle. Potential partners include major retailers, | points |
| movie, music and game studios, and national brands. | |
| Wraps would be changed out periodically, and pricing | |
| based on the traffic density it is exposed to. | |
| Have seat covers and seatbelts patterned with the logos | 15 |
| from an upcoming energy drink. | points |
| Try a new youth-focused grooming product. (May be | $0.50 |
| limited to, e.g., 10,000 owner-driver participants) | credit on |
| | purchase |
| | or |
| | equivalent |
| Participate in a scavenger hunt-style game arranged by | $2.00 |
| XYZ motion picture studios to create buzz around the | credit on |
| announcement of a new superhero movie debuting an | purchase |
| upcoming film festival. | or |
| | equivalent |

At block 510, the processing hardware unit presents the task(s) and corresponding detail(s) (e.g., amount of corresponding reward or incentive) to the owner-driver participant. The tasks can include those required by agreement. The tasks in some embodiments include tasks related to a topic, group, genre, or area of interest deemed by driver input or driver characteristics or behavior, to be of interest, or likely or apparent interest, to the driver.

The functions of block 510 can be performed by the system-driver interaction (SDI) module 150, for example, or another module 170. The other module 170 could include, for instance, a task-obtaining module.

At block 512, the processing hardware unit receives task feedback, including driver input to the system, or other response or responsive communication relating to driver performance regarding a subject task(s).

The functions of block 512 can be performed by the system-driver interaction (SDI) module 150, for example, or another module 170. The other module 170 could include, for instance, a task-obtaining module.

As with any other function of the present technology, for implementations in which this function (e.g., receiving task feedback) includes using information from a computing system (e.g., server) of a third party, the system can be configured to obtain the feedback by way of an application-program interface (API) of the server, for instance.

At block 514, the processing hardware unit monitors and/or evaluates driver-participant performance over time. Functions of this block 514 can also include ensuring that the owner-driver participant perform a required level of system-driver interactions in accord with a driver-participant account. In some embodiments, the functions include performing maintenance functions for the driver-participant account. Maintenance functions include, for example, recording extents to which the owner-driver participant is performing according to the corresponding driver-participant agreement, such as owner-driver participant actions, or associated driver-participant points, dollar values, or other incentives earned by the driver in connection with one or more applicable subsidies.

The functions of this block 514 can include communication with a third-party computer system, such as a server of a program participant. The server can be contacted by way of an application-program interface (API), for instance.

The functions of this block 514 can be performed by the incentives-monitoring (IM) module 160. In various embodiments, the functions are performed by at least one of the IM module 160, the system-driver agreement (SDA) module 140, and one or more other modules 170.

At block 516, the processing hardware unit allots, allocates, or otherwise applies credits, such as points, funds, or other values due to the driver-participant account. For instance, if the driver performs a task associated with a fifty-point incentive, then the operation involves applying the fifty points to the driver-participant account.

The functions of this block 516 can include communication with a third-party server, such as by way of an application-program interface (API) of the third-party server.

The functions of this block 516 can be performed by the incentives-monitoring (IM) module 160. In various embodiments, the functions are performed by at least one of the IM module 160, the SDA module 140, and one or more other modules 170.

At block 518, the processing hardware unit determines whether any adjustments should be recommended to the driver based on any of various factors. The factors can include, for instance, driver-participant behavior, such as driver task selections and driver performance on tasks.

As one example, the drive-participant behavior can include simply the location of the vehicle (i.e., where the driver took or is taking the vehicle). The system can select advertisements or tasks related to a present or expected, imminent location, such as a coupon for a nearby coffee shop.

As another example, if the system determines a driver habit, such as determining that the driver has a habit of going to the supermarket store on Sunday afternoons, the system can select advertisements or tasks related to grocery shopping for presentation at or before that time slot. The task could include, for instance, visiting store X (if the user usually visits store Y, for example), for points or a discount at store X. Or the task could involving trying a new product or a product the driver does not usually use.

As a similar example, if the driver is determined real-time to be visiting a particular establishment—e.g., a movie theater—the system could determine to present an advertisement or task related to that establishment or a competitor establishment. The system in various embodiments is configured to determine the user intention in any of a variety of ways. The system could, for instance, determine driver intent by driver-participant input received in response to a system inquiry present to the driver, at vehicle start, inquiring about driver intent. Or the system could determine a most-likely intent based on user factors such as driver-account demographic information (residence, work address), behavior (e.g., area driving in, statement that hungry, etc.), and/or habit data.

As another example, if the driver is determined real-time to be visiting a type of establishment—e.g., a gas station, but not a particular station—the system could determine to present an advertisement or task related to a particular establishment or product within gas stations, such as a soda.

As another example, if the driver is presented with (i) multiple sports-related tasks—such as tasks relating to visiting a sporting goods store, and tasks relating to watching videos regarding sporting products, sporting media, etc.—and with (ii) multiple education-related tasks—such as tasks relating to book stores and tasks related to university programs, and the driver selects and performs the education-related tasks exclusively or more often, then the system may be configured to, response to identifying the tendency, propose to the driver an adjustment whereby more education-related tasks, or tasks more closely aligned with education than sports, are presented to the driver participant.

The functions of this block 518 can be performed by the incentives-monitoring (IM) module 160. In various embodiments, the functions are performed by at least one of the IM module 160, the SDA module 140, and one or more other modules 170.

At block 520, the processing hardware unit implements any adjustment that, at block 518, (a) has been approved by the driver participant or (b) has otherwise been determined to be implemented. The adjustment can include adjusting the driver-participant account, for instance. The functions of this block 520 are in various embodiments performed by the same module that performed the functions of block 518.

From any function described, the method 500, or any portions thereof in particular, could be repeated, as indicated generically by return path 521 in FIG. 5, or end 523.

### V. ADDITIONAL FEATURES

The present section summarizes some embodiments described above, adds to the teachings of some, and describes additional embodiments.

The system(s) of the present technology in various embodiments provides a reputation-based exchange arrangement for rides, deliveries, and/or other services. The system can be configured to present such tasks to owner-driver participants, such as to participants who expressed interest in such tasks). An owner-driver participant may be attracted to participating in this optional aspect of the program if, for instance, the participant has extended periods of their day in which they would like to exchange their time and energy delivering packages or giving rides to locals for program points or other incentives.

The system can further be configured to track performance of owner-driver participants in completing the tasks, such as timeliness, scores in reviews of passengers or package recipients, the like, or other. The system can also manage a driver-participant rank or overall score accordingly, and potential users (e.g., package recipients or those needing a ride) can select a deliverer or driver based thereon.

The system(s) of the present technology in various embodiments determines and facilitates delivery of tangible rewards to drive participants who have earned them. An example reward is automotive maintenance in return for program points and/or in return directly for performing a related task—e.g., uploading to social media page a photo of self in front of a corresponding automobile service center. In some embodiments, points used can be those in the driver-participant account after points for subsidizing purchase of vehicle ownership rights has been made, or in some embodiments, instead of using the points for subsidizing the ownership rights.

Some embodiments can be referred to as gamifying the interaction, providing a game-quality or using game-theory to promote system adoptions, use, and enjoyment.

The present technology, in various embodiments, includes a social-media-powered platform allowing owner-driver participants to monetize their in-car time through engagement with program partners (or program sponsors, or advertisers), in return for a subsidization of the driver's vehicle lease, vehicle purchase, wireless plan, or car-share subscription.

In one embodiment, the technology involves a smart phone application interacting with a vehicle application (e.g., vehicle Info 3.0 app). The two applications can be referred to as being linked. A system, including both apps or just one of the apps interacting with the other app, is configured to allow owner-driver participants, to perform one or more of (i) choosing which engagements they want to participate in, (ii) collaborating with other users around group engagements, leveraging social media, location-based services, etc., (iii) managing ongoing engagements, (iv) making in-car purchases, (v) controlling of the vehicle's HMI system to enable in-car “engagements” for reward points, such as (v)(1) “Watch video before key start” model, as in an internet video app, (v)(2) “Listen to Ads while driving” as on an internet music-streaming app, (v)(3) enable passengers to complete engagements as a way of helping to pay for the car—“virtual gas money”, (v)(4) reputation-based exchange system for rides, deliveries and other services, and (v)(5) intent-driven pre-ignition questions “where are we going today?”

In one embodiment, the technology involves a backend system. The backend system in embodiments includes a program-administrator-facing component and a program-partners-facing component.

The program-administrator-facing component of the backend system can be maintained and operated by an entity administering the program. The entity can be referred to as a program administrator. The system is configured to manage and monitor task selection and performance, or “engagements,” track driver-participant activity, such as the tasks selected, determine which are successful, etc. Determining whether a task is successful can be based on any of a variety of metrics as a system designer may specify. For instance, if a goal of a task is to increase traffic to a new restaurant, an increase, over a pre-set success threshold, in traffic attributable to the program would qualify as a success. Or success could be linked to a pre-determined amount of views by drivers in the program of a particular ad. The system in various implementations collects opt-in data, which can later be used for internal marketing or anonymized and used by partners. The data is collected after driver opt-in to protect privacy.

The program-partners-facing component of the backend system can be configure to administer operations related to connecting partnering, or potential-partnering, entities to the program or to new engagements of the program. The connecting can involve receiving an agreement from an entity (e.g., advertiser) to purchase at least one engagement. In one embodiment, the component administers a bidding process through which program partners or potential partners bid on the right to provide their engagements through the system. For instance, CVS and Walgreen's may bid through the component to determine which company will sponsor a drug-store-related engagement to be presented to owner-driver participants as part of the program.

In various embodiments, the program-partners-facing component of the backend system is configure to manage (e.g., generate, tailor, and monitor) messaging provided to owner-driver participants. The managing can include determining which engagements are presented to an owner-driver participant, and how. The managing can include determining how often the system communicates with the owner-driver participant. For instance, the system is programmed so that the owner-driver participant is not contacted too often, to avoid annoying the driver. Annoying the driver could lower owner-driver participant motivation, program effectiveness, etc. The managing can include, for instance, providing a driver message asking the driver whether they would like the system to stop sending a certain type of communication or adjust a timing of communications. In embodiments, the managing involves provide a mechanism by which the driver can indicate that they would like a different type and/or timing of communications from the system.

In various embodiments, the technology includes and/or is in communication with a secure e-payment system, such as a credit-card or mobile-wallet system. The e-payment system is configured to allow the owner-driver participant to execute purchase transactions, such as transactions initiated through an engagement. If a task, presented to the owner-driver participant while the driver participant is driving, involves visiting a new restaurant, for example, the e-payment system can include an application on the owner-driver participant's mobile-communication device allowing the owner-driver participant to purchase the product once in the establishment. In some embodiments, the program system is configured so that the purchase is accounted for in the driver-participant's account. In some embodiments, the program system is configured so that the owner-driver participant receives a discount for being a program participant or based on having reached the establishment (e.g., restaurant) by way of program use. The e-payment system is configured to enable retail analytics and offers.

As provided, the system in various embodiments includes any one or more of the following components. The components, including those referenced above in this section and above in connection with the arrangement or overall system 400 of FIG. 4, are described further as follows.

### V.A. OBC

An on-board computer (OBC) at the vehicle in various embodiments comprises a program application that communicates with a server of an operator of the program. A driver mobile-communication device (MCD) in some embodiments also includes paired program application.

The OBC application, via vehicle hardware, communicates with other components of the arrangement, such as a driver MCD, a remote e-payment system, and one or more of the servers shown in FIG. 4.

In FIG. 4, the vehicle transmitting communications is indicated by numeral 100, the communication network(s) is indicated by numeral 130, the MCD by numeral 410, and the administrator server can be considered indicated by numeral 430¹. Any one or combination of the components of the arrangement 400 perform functions including tracking and/or managing driver activities, such as completion of engagements and progress towards point goals, and obtaining (e.g., determines or receives) and presenting to the driver new engagements.

In various embodiments the OBC app presents, via vehicle output hardware (e.g., vehicle HMI), and allows the driver to choose, via vehicle input hardware (e.g., vehicle HMI), from engagements that the owner-driver participant would like to participate in. And the OBC app is in some embodiments configured to allow the driver to initiate purchase, such via vehicle hardware and a linked e-pay system, of services or products presented by way of a task or engagement of the program. In some embodiments, the purchase can be made at least in part using program points.

### V.B. Driver Mobile-Communication Device(s)

An owner-driver participant mobile-communication device (MCD) in various embodiments comprises a mobile application that, via MCD hardware, communicates with other components of the arrangement, such as the OBD application, the e-payment system, and one or more of the servers shown in FIG. 4.

The MCD application communicates with the administrator server 430¹ and any of the other servers of FIG. 4 as needed for performance of the functions described herein. The OBC app can include a paired program application, paired with the MCD app.

As provided, any one or combination of the components of the arrangement 400 perform functions including tracking and/or managing driver activities, such as completion of engagements and progress towards point goals, and obtaining (e.g., determining or receiving) and presenting new engagements to the owner-driver participant.

In various embodiments the MCD app presents and allows the owner-driver participant to choose from engagements that the owner-driver participant would like to participate in. And the MCD app in some embodiments is configured to allow the owner-driver participant to initiate purchase, such via a linked e-pay system, of services or products presented by way of a task or engagement of the program. In some embodiments, the purchase can be made at least in part using program points earned by the owner-driver participant.

### V.C. E-Payment Infrastructure

The e-pay system can perform functions including providing a structure for allowing the driver, by way of an app being used, make secure mobile payments. The e-pay system in some embodiments also tracks transactions through the program application. The e-pay system can provide purchase-linked or other rewards to the driver in addition to or instead of incentives that are provided to the user by their driver-program account in connection with purchases.

The secure e-payment system in embodiments combines functions of a credit card and mobile wallet in connection with operations of the program application operating at the vehicle or MCD.

Purchases can be made, for example, via an MCD near-field-communication (NFC) system.

The e-pay system in embodiments supports retail analytics and validation of completed engagements. The system can track purchases of a driver, for instance, and process the data to recognize trends, user preferences, user behaviors, or the like. The system preferably is configured to obtain in advance driver opt-in to such uses of such information.

In one embodiment, a program administrator is paid by agreement a share of transactions fees, such as a percentage of each purchase made or initiated through use of the program.

### V.D. Program-Administrator Server

The program-administrator server or server system (P-A server) manages a driver profile, or driver account. As mentioned, the server can be that shown by numeral 430¹ of FIG. 4. The server is operated by a program administrator. In one embodiment, the server is part of a customer services centers, such as the OnStar® system.

The P-A server communicates with any of the other components shown in FIG. 4 as needed for performance of the functions described herein. As provided, any one or combination of the components of the arrangement 400 perform functions including tracking and/or managing driver activities, such as completion of engagements and progress towards point goals, and obtaining (e.g., determines or receives) and presenting new engagements to the owner-driver participant.

The system of the present technology, including the P-A server 430¹ can include or be a part of a backend system. The backend system can include a program-administrator-facing (P-A-facing) component and/or a program-sponsor-facing (S-P-facing) component. Generally, the P-A-facing component manages interactions with the owner-driver participant, and the S-P-facing component manages engagements (sells new, including via partner and/or potential-partner bidding process administered by the component).

Other example P-A-facing component functions include allowing the program administrator to manage and monitor engagements, track user activity, determine which are successful, etc., as described more above.

Still other example P-A-facing component functions include collecting data which can later be used for internal marketing or anonymized and sold to program partners. The system is preferably configured to obtain driver opt-in for such uses. The information can be useful to the program administrator or program partners, such as to mapping vehicle-driver-participant trends across numerous owner-driver participants, correlate owner-driver participants with engagements completed, and refine the system, such as toward creating more compelling offers or engagements for a particular owner-driver participant, all owner-driver participants, or a segment of all owner-driver participants.

Other example S-A-facing component functions include assisting program partners with managing (e.g., tailoring and/or improving) their messaging to owner-driver participants. The component can, for instance, be configured to generate or recommend an improved advertisement or task structure (e.g., task wording, or details such as task point allowance).

### V.E. Third-Party Servers

As provided, obtaining tasks or engagements can include communications with a computing system—e.g., server—of a third party, such as a program participant or sponsor. The server can be contacted by way of an application-program interface (API), for instance.

Other functions of the third-party servers can include any of those outlined above in connection with blocks 510, 512, 514, 516, for example.

### VI. SELECT BENEFITS OF THE PRESENT TECHNOLOGY

Many of the benefits and advantages of the present technology are described above. The present section restates some of those and references some others. The benefits described are not exhaustive of the benefits of the present technology.

The system and methods of the present technology allow consumers having limited means, or who may not otherwise consider obtaining vehicle-ownership rights, to obtain vehicle-ownership rights in exchange for a contribution of some of their time and attention.

Program partners, such as marketers, retailers, and brand owners, can get their message to target one or more customer segments, such as millennial customers, in a novel way. This could be especially valuable to partners who had trouble previously penetrating the one or more target segments.

For a program participant who is also a manufacturer of the vehicle(s), or other provider of the vehicle(s), being used in the program, the participant could benefit from increased visibility and adoption of their vehicles generally, or in the target segment.

The systems of the present technology can on occasion increase sales of more-expensive vehicles, as a customer may feel more comfortable buying a more expensive car with the subsidy to ownership rights than they would without the subsidy.

For embodiments in which non-vehicle products or services are subsidized according to the present technology, the program is expected to increase sales likewise of those services or products. The services in this case can include wireless access via the vehicle. Consumers for subsidized wireless access can include first-time, or entry level, buyers, for instance.

The technology also provides a platform, being attractive to owner-driver participants and partner participants, allowing partner participants to extend their brands into the in-vehicle environment. The incursion is welcomed or less-obtrusive to owner-driver participants in this case because they have elected the program in the first place. And in various embodiments the owner-driver participant can, via the system, tailor the interactions to their interests. In some embodiments, the system automatically tailors the interactions in this way.

For a program participant who is also a manufacturer, or other provider, of the vehicle(s) being used in the program, the program administrator can profit in various ways by providing the program, including (i) receiving a share (e.g., percentage) or other payment in connection with each engagement established with a program partner. In some implementations, the program participant received a share or other payment in connection with establishing a program/partner relationship in the first place.

For a program participant who is also a manufacturer, or other provider, of the vehicle(s) being used in the program, the program administrator can profit by selling opt-in, aggregated, anonymized customer data to third parties. As provided, the data obtained is preferably opt-in to preserve driver-participant privacy. Data can indicate demographics, such as a number of persons between the ages of 25-35 who shop at a certain shopping mall at least once per quarter, or at a particular establishment during this time. As another example, data can indicate levels of performance of program participants—e.g., 60% of participants responded positively (e.g., positive remarks, or visited recommended establishment) to ABC-type of engagement, while 80% responded positively to XYZ-type of engagement.

The program is expected to be well received by all consumer segments, and especially particular consumer segments such as millennials who are entering ages at which they will begin purchasing vehicles and who are more familiar and comfortable with increased electronic connectivity.

The systems of the present technology also allow more accurate advertising by tailoring tasks or advertisements presented to driver intent.

The systems of the present technology also allow program administrators, who also manufacture or otherwise provide vehicles used in the program, to improve brand or make perception among all or at least one or more target groups, such as millennials. The program can increase brand or make awareness and move the image for a brand or make more toward being ‘young,’ ‘hip,’ ‘understanding’ (i.e., understanding (from perspective of a young person) of my life/lifestyle: schedule, needs, habits, interests, etc.), by enabling vehicle ownership rights by the program and, in embodiments, by providing tasks and offers aligned with their lifestyle and/or their choices. People will be more attracted to participating in the program if they find that it complements their lifestyle, such as by providing convenient, non-annoying, ways to interact with, and benefit from, the program.

In some embodiments, how the system interacts with the owner-driver participant is affected at least in part by the owner-driver participant, such as the owner-driver participant affecting how often or when advertisements are presented. This is another way that owner-driver participants are more likely to embrace the technology, and recommend it to others.

In one embodiment, the vehicle ownership rights are provided according to the program, as a trial of the vehicle. In this way, a vehicle-manufacturer or other product provider who is also the program administrator can invest in future sales, building brand recognition and perhaps loyalty.

In addition to providing owner-driver participants with a way to leverage their in-car time for value, the present system is in embodiments configured to allow passengers to do the same. The system provides program points to the driver-participant account when the owner-driver participant initiates use of the system by a passenger in the driver's vehicle in some implementations. Or the system can provide points to the owner-driver participant based on passenger actions, such as but not limited to interactions with the system. If the passengers agrees through the HMI to, as a guest, watch a video advertisement, the vehicle-driver-participant account will be credited with a corresponding pre-assigned number of points. In these ways, passengers can provide benefits to the driver. These benefits can be viewed as virtual gas money, a modern example of the classic passenger contribution wherein a passenger contributes some money to the driver in exchange for, or at least as thanks or consideration for the driver transporting the passenger.

Another benefit of the present technology is that passengers experiencing the system could become owner-driver participants themselves based on the experience.

For a vehicle manufacture, who may also be the administrator of the program provided by the present technology, cost may be saved in vehicle production in connection with finish of a surface to be covered by advertising decals or paint jobs. The surface could not be painted, painted in a less-expensive manner, or covered or made with less-costly material (e.g., a less-costly metal finish), for instance.

For embodiments in which program partners and/or potential program partners compete to sponsor program engagements, the competition could spur development of attractive and engaging physical vehicle modifications that get the advertiser's message across and are desirable alternatives for drivers. Artistic paint jobs advertising a brand or make of a corresponding program partner can be attractive to owner-driver participants, for instance, making program participation more attractive for existing and potential future driver participants.

In one embodiment, a program administrator is paid by agreement a share of transactions fees, such as a percentage of each purchase made or initiated by the owner-driver participant through or in response to use of the program.

### VII. CONCLUSION

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A system, for providing subsidized vehicle-ownership rights based on driver participation in a driver-participation incentive program, comprising:
a processing hardware unit;
a system-driver agreement module configured to, via the processing hardware unit, establish an agreement with a driver participant by which the driver participant agrees to perform a task related to driving a vehicle in exchange for a subsidy toward obtaining the vehicle-ownership rights;
an account-maintenance module configured to, via the processing hardware unit, establish a driver-participation account in connection with the driver participant;
a system-driver interface module configured to, via the processing hardware unit:
present, by way of a tangible vehicle interface of the vehicle, a task for the driver participant to perform; and
determine that the driver participant performed the task; and
a driver-incentives module configured to, via the processing hardware unit:
add program points to the driver-participant account in response to the system-driver interface module determining that the driver participant performed the task; and
apply the program points to the subsidy toward obtaining the vehicle-ownership rights.

2. The system of claim 1, further comprising the tangible vehicle interface by way of which the system-driver interface module communicates the task to the driver participant.

3. The system of claim 1, wherein the vehicle-ownership rights comprise a right selected from a group consisting of:
ownership of the vehicle;
a car-share subscription;
a subscription to a mobility plan that may include shared vehicle or multi-modal transportation system access;
a subscription to an online service plan that may include vehicle data or digital service/concierge access; and
a vehicle lease.

4. The system of claim 1, wherein the system-driver interface module is further configured to, via the processing hardware unit, determine the task.

5. The system of claim 4, wherein the system-driver interface module, via the processing hardware unit, determines the task based on driver-participant input received by way of the tangible vehicle interface of the vehicle.

6. The system of claim 4, wherein the system-driver interface module, via the processing hardware unit, determines the task based on driver-participant behavior.

7. The system of claim 4, wherein the system-driver interface module, via the processing hardware unit, determines the task based on vehicle location.

8. A method, for providing subsidized vehicle-ownership rights based on driver participation in a driver-participation incentive program, comprising:
establishing, by a processing hardware unit of a system executing a system-driver agreement module of the system, an agreement with a driver participant by which the driver participant agrees to perform a task related to driving a vehicle in exchange for a subsidy toward obtaining the vehicle-ownership rights;
establishing, by the processing hardware unit executing an account-maintenance module of the system, a driver-participation account in connection with the driver participant;
presenting, by the processing hardware unit executing a system-driver interface module of the system, and by way of a tangible vehicle interface of the vehicle, a task for the driver participant to perform;
determining, by the processing hardware unit executing the system-driver interface module of the system, that the driver participant performed the task;
adding, by the processing hardware unit executing a driver-incentives module, program points to the driver-participant account in response to the system-driver interface module determining that the driver participant performed the task; and
applying, by the processing hardware unit executing the driver-incentives module, the program points to the subsidy toward obtaining the vehicle-ownership rights.

9. The method of claim 8, wherein the system comprises the tangible vehicle interface by way of which the tangible processing unit communicates the task to the driver participant.

10. The method of claim 8, wherein the vehicle-ownership rights comprise a right selected from a group consisting of:
ownership of the vehicle;
a car-share subscription;
a subscription to a mobility plan that may include shared vehicle or multi-modal transportation system access;
a subscription to an online service plan that may include vehicle data or digital service/concierge access; and
a vehicle lease.

11. The method of claim 8, further comprising determining the task by the processing hardware unit executing the system-driver interface module.

12. The method of claim 11, wherein determining the task is performed based on driver-participant input received by way of the tangible vehicle interface of the vehicle.

13. The method of claim 11, wherein determining the task is performed based on driver-participant behavior.

14. The method of claim 11, wherein determining the task is performed based on vehicle location.

15. A non-transitory computer-readable storage device, for providing subsidized vehicle-ownership rights based on driver participation in a driver-participation incentive program, comprising:
a system-driver agreement module configured to, via a processing hardware unit, establish an agreement with a driver participant by which the driver participant agrees to perform a task related to driving a vehicle in exchange for a subsidy toward obtaining the vehicle-ownership rights;
an account-maintenance module configured to, via the processing hardware unit, establish a driver-participation account in connection with the driver participant;
a system-driver interface module configured to, via the processing hardware unit:
present, by way of a tangible vehicle interface of the vehicle, a task for the driver participant to perform; and
determine that the driver participant performed the task; and
a driver-incentives module configured to, via the processing hardware unit:
add program points to the driver-participant account in response to the system-driver interface module determining that the driver participant performed the task; and
apply the program points to the subsidy toward obtaining the vehicle-ownership rights.

16. The non-transitory computer-readable storage device of claim 15, wherein the vehicle-ownership rights comprise a right selected from a group consisting of:
ownership of the vehicle;
a car-share subscription;
a subscription to a mobility plan that may include shared vehicle or multi-modal transportation system access;
a subscription to an online service plan that may include vehicle data or digital service/concierge access; and
a vehicle lease.

17. The non-transitory computer-readable storage device of claim 15, wherein the system-driver interface module is further configured to, via the processing hardware unit, determine the task.

18. The non-transitory computer-readable storage device of claim 17, wherein the system-driver interface module, via the processing hardware unit, determines the task based on driver-participant input received by way of the tangible vehicle interface of the vehicle.

19. The non-transitory computer-readable storage device of claim 17, wherein the system-driver interface module, via the processing hardware unit, determines the task based on driver-participant behavior.

20. The non-transitory computer-readable storage device of claim 17, wherein the system-driver interface module, via the processing hardware unit, determines the task based on vehicle location.
